(19) United States
(12) Patent Application Publication
(10) Pub. No.: US 2012/0167448 A1
(43) Pub. Date: Jul. 5, 2012

(54) HUMANE RACCOON LEG HOLD TRAP

(76) Inventor: Bobbie Lee Collins, II, Kansas City, MO (US)

(21) Appl. No.: 12/984,661

(22) Filed: Jan. 5, 2011

(51) Int. Cl. A01M 23/00

(52) U.S. Cl. 43/58

(57) ABSTRACT

A humane animal leg hold trap designed to restrain a Raccoons paw or foreleg. The trap has an enclosed bait area behind a pivoting gate. The gate opens when the Raccoon pushes on it with its paw and foreleg to reach for the bait. The Raccoon's paw or foreleg then becomes wedged between the gate and the housing. The Raccoon provides the holding force of the trap by attempting to remove its paw or foreleg from the trap. The trap has a double swivel anchor chain attached to the traps anchor bail which restrains the Raccoon and the trap at the traps set location.

This is a non-provisional application relating to Humane Leg Hold Traps for Raccoons.

### BACKGROUND OF THE INVENTION

1. Field of the Invention

This invention relates to traps specially to the Humane Leg Hold Traps for Raccoons.

2. Description of the Related Art

The art of trapping dates back to the beginning of man and is one of the oldest forms of harvesting animals. Trapping does not require that the trapper be present when the animal is active or at a specific location. The trap is set at a location and is there waiting for the animal to pass by and work the set. The settling of North America was based partly on the trapping of wild animals. The animals provided the Native Americans the Settlers and the Trappers with food and clothing. An additional benefit was the influx of goods and money into the economy of North America from the animals fur and meat. Today's modern trapping methods provide a service to society by the controlled removal of a small percentage of the population of Furbearing animals. This helps to control the over population of the Furbearing animals the transmission of animal diseases the destruction of property and provides for additional economic benefits.

There are six main divisions that traps can be placed in; leg holds snares spring loaded leg hold snares spring loaded body snares cages and body gripping traps. A subdivision of the leg hold trap is the Humane Raccoon Leg Hold Trap. These traps are designed to target the Raccoon specifically. All of these trap types except the snare requires an interaction between the targeted animal and the traps trigger in order to release the jaws of the leg hold trap close the loop of the leg hold and body snares close the door of the cage trap or to release the jaws of the body grip trap.

The current Humane Raccoon Leg Hold Traps are complicated and costly products to produce. These traps require compression coil or torsion springs that are activated by a triggering device. When the Raccoon activates the triggering device by pressure or by the pushing or pulling of the trigger it releases the traps holding device (i.e. a pair of jaws door or formed wire) which traps the Raccoon. The springs hold the animal holding device in place with a constant pressure which can provide an excess of force on the paw or foreleg of the Raccoon. This can result in the animal chewing off its own paw or foreleg from the lack of blood circulating through the leg and the pinching off of the nerves. The current production sizes of the leg hold traps designed specifically for the Raccoon are designed to have a clamping force of 13 to 60 foot pounds on the Raccoon's paw or foreleg while the Raccoon is restrained by the trap. A majority of these traps require a special tool or excessive force to set the trap.

The art of the Humane Raccoon Leg Hold Trap needs to; have fewer and less complicated parts be more cost effective to produce have no triggering device provide less clamping force require no setting tool or have less or no force required to set the trap.

### SUMMARY OF THE INVENTION

The present invention provides a Humane Raccoon Leg Hold Trap that has only two moving internal parts and no triggering device.

The invention encompasses a housing that surrounds a gate assembly and a 90 degree flat spring with an opening at one end and an enclosed bait holding area at the other end.

The advantages of the present invention is that; it is comprised of fewer moving parts is more cost effective to produce requires less machining has no triggering device does not require a special setting tool or excessive force to set the trap.

Another advantage of the invention is that the force applied to the animals paw or foreleg is directly proportional to the force applied by the animal attempting to remove its paw and foreleg from the trap which allows for the animal to be released without injury. The trap has less than 13 foot pounds of force applied to the Raccoon's paw or foreleg by the traps 90 degree flat spring and restraint gate assembly.

### BRIEF DESCRIPTION OF THE DRAWINGS

The aforementioned features and other features and advantages of this invention and the means of obtaining them will be more apparent to an observer of the invention by the association with the following description of an embodiment of the invention and encompassing its associations with the accompanying drawings wherein:

FIG. 1 is an isometric view partially broken-out to show the internal components of a Humane Raccoon Leg Hold Trap which embodies the features of this invention;

FIG. 2 is a top view of a Humane Raccoon Leg Hold Trap and its external components.

Like reference characters refer to like parts throughout the two views of the drawings. The exemplification's set out herein illustrates only one form of the preferred embodiment of the invention and such exemplification is not to be interpreted as limiting the extent of the invention in any manner.

### DETAILED DESCRIPTION OF THE INVENTION

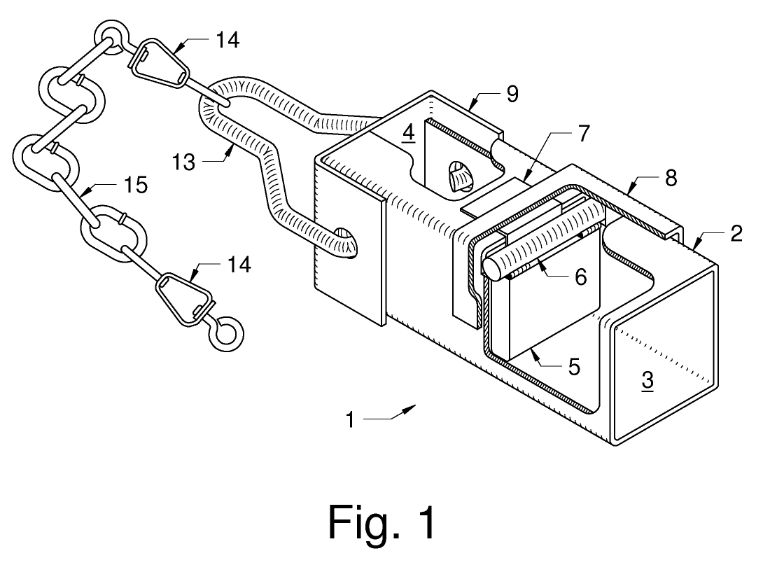

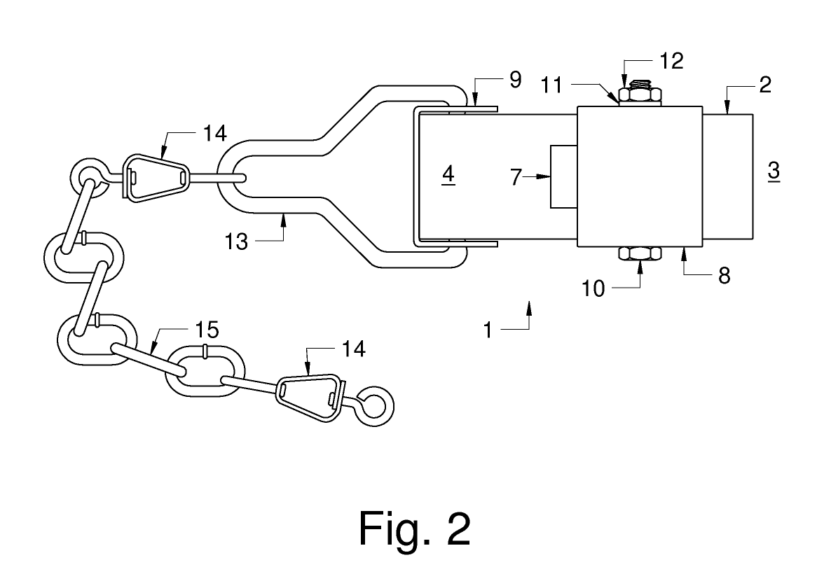

Referring now to the drawings and more particularly to FIGS. 1 and 2 there is shown an embodiment of a Humane Raccoon Leg Hold Trap 1 of the present invention. The trap 1 consists of a housing 2 an end opening 3 an enclosed bait holding area 4 a restraint gate 5 attached to a restraint gate pin 6 a 90 degree flat spring 7 a housing cover 8 an end cover 9 a hex head bolt 10 a lock washer 11 a hex nut 12 a means of anchoring the trap consisting of an anchor bail 13 two double swivels 14 and anchor chain 15. The housing 2 and the housing cover 8 includes aligned holes through which the hex head bolt 10 passes through to fasten the housing cover 8 to the housing 2 and to retain the 90 degree flat spring 7 and the restraint gate 5 attached to the restraint gate pin 6 in place. The hex head bolt 10 also provides a stop for the restraint gate 5. The housing 2 and the end cover 9 includes aligned holes through which the anchor bail 13 attaches the end cover 9 to the housing 2 which provides for the enclosed bait holding area 4. The housing 2 also includes a slot cut within the top of the housing 2 through which the 90 degree flat spring 7 and the restraint gate 5 attached to the restraint gate pin 6 are inserted and where they rest and the restraint gate pin 6 pivots. Bait is placed in the trap through the end opening 3 while depressing the restraint gate 5 with a finger or other object toward the enclosed bait holding area 4 and placing the bait within the enclosed bait holding area 4.

While this invention has been described as having a preferred design the present invention can be further modified within the spirit and scope of this disclosure. This application is therefore intended to cover any variations uses or adaptations of the invention using its general principles. Further this application is intended to cover such departures from the present disclosure as come within known or customary practice in the art to which this invention pertains and which fall within the limits of the appended claims.

What is claimed is:

1. A Humane Raccoon Leg Hold Trap comprising;
a housing that is enclosed with an end opening and an enclosed bait holding area
a non triggered restraint gate assembly consisting of a restraint gate and pin with a 90 degree flat spring behind the restraint gate which are located within the housing
said restraint gate assembly will secure the paw or foreleg of a Raccoon which has been inserted into the said housing through the end opening and
restrain the Raccoon at the trap set location through the use of an anchor bail attached to the housing of the trap and
two double swivels one at each end of the anchor chain attached to the said anchor bail
requires no special setting tool or excessive force to set the trap
trap is always set

2. The Humane Raccoon Leg Hold Trap as claimed in claim 1 wherein said non-triggered restraint gate assembly and said 90 degree flat spring behind the said restraint gate assembly rests in a slot of said housing and said restraint gate assembly provides for the said enclosed bait holding area behind the said restraint gate assembly.

3. The Humane Raccoon Leg Hold Trap as claimed in claim 2 wherein said bait is placed in the said enclosed bait holding area and the said Raccoon pushes the said restraint gate assembly open with its said paw and foreleg against the force of the said 90 degree flat spring and reaches for the said bait and attempts to remove said bait from the said enclosed bait holding area.

4. The Humane Raccoon Leg Hold Trap as claimed in claim 3 wherein said Raccoons paw and foreleg becomes engaged (wedged) against the bottom of the said restraint gate assembly and the inside bottom of the said housing.

5. The Humane Raccoon Leg Hold Trap as claimed in claim 4 wherein said Raccoons paw and foreleg is restrained within the said housing and is held there by the force of the said Raccoon attempting to remove its paw and foreleg from the said housing.

6. The Humane Raccoon Leg Hold Trap as claimed in claim 1 wherein said double swivels and said anchor chain attached to the said anchor bail will restrain the said Humane Raccoon Leg Hold Trap and said Raccoon at the set location through the use of a ground anchor grapple drowning device or fastened to a fixed object at the set location through the end double swivel.

7. The Humane Raccoon Leg Hold Trap as claimed in claim 1 wherein said Humane Raccoon Leg Hold Trap requires no said special setting tool and requires no said excessive force to set the Humane Raccoon Leg Hold Trap as said trap is always set.
